(19) United States
(12) Patent Application Publication
(10) Pub. No.: US 2014/0090515 A1
(43) Pub. Date: Apr. 3, 2014

(54) Method for Fracture Splitting Workpieces, Workpiece, and Laser Unit

(71) Applicants: Siegfried Gruhler, Vohringen (DE); Willi Breithaupt, konigsfeld (DE); Joachim Klein, Oberndorf (DE); Horst Schöllhammmer, Trichtingen (DE)

(72) Inventors: Siegfried Gruhler, Vohringen (DE); Willi Breithaupt, konigsfeld (DE); Joachim Klein, Oberndorf (DE); Horst Schöllhammmer, Trichtingen (DE)

(73) Assignee: Mauser-Werke Oberndorf Maschinenbau GmbH, Oberndorf am Neckar (DE)

(21) Appl. No.: 14/110,023

(22) PCT Filed: Apr. 10, 2012
(86) PCT No.: PCT/EP2012/056480

§ 371 Date: Nov. 5, 2013

(30) Foreign Application Priority Data
Apr. 6, 2011 (EP) PCT/EP2011/055384

(51) Int. Cl. B23K 26/38

(52) U.S. Cl. CPC B23K 26/38
USPC 74/579 R; 219/121.72; 74/606 R; 219/121.67

(57) ABSTRACT

The invention relates to a method for fracture splitting workpieces and to a workpiece that is produced according to such a method. According to the invention, the feed rate and/or the laser pulse is modulated during the laser machining process dependent on the workpiece geometry and/or the laser power.

### BACKGROUND OF THE INVENTION

1. Field of the Invention

The invention relates to a method for fracture splitting of workpieces in accordance with the preamble of claim 1, a workpiece manufactured according to such method as well as a laser unit.

2. Description of Related

In applicant's document EP 0 808 228 B2 a generic fracture splitting method is described in which a notch predefining the fracture plane is formed in a connecting rod top end to be fracture split by means of laser energy. Such notch consists of a plurality of notch sections the distance of which substantially results from the pulse rate of the laser and the feed rate of the laser beam relative to the connecting rod top end. It turned out that the stress concentration factor can be considerably increased vis-à-vis continuous notches by such notch sections so that it is possible to form a notch by comparatively small laser power. This small laser power and the accompanying low thermal energy introduced prevent undesired deep structural changes in the notch area, wherein a structural change is merely imparted to particular marginal zones of the notch winch thus improve the fracture splitting behavior,

In applicant's document DE 2005 031 335 A1 an improved method is described in which the notch does not exhibit a straight shape but a sine shape having straightly extending end portions. Surprisingly it turned out that the fracture splitting behavior can be further improved by such notch design.

Laser notches including such notch sections have established themselves especially in fracture splitting of connecting rods and crankcases as state of the art, because the fracturing behavior of such notches is superior to that of continuous notches. Despite these positive fracture splitting characteristics, there is an effort to further improve the fracture splitting behavior.

### SUMMARY OF THE INVENTION

Compared to this, the object underlying the invention is to provide a method that permits producing notch sections of a fracture splitting notch with little effort. It is moreover an object of the invention to provide a workpiece manufactured in accordance with such method and a laser unit for implementing such method.

This object is achieved by a method comprising the combination of features of claim 1, by a workpiece comprising the features of the independent claim 10 and a laser unit comprising the features of claim 12.

In the method according to the invention—similarly to conventional procedures—a laser notch is formed by means of laser energy, said notch having a plurality of notch sections. According to the invention, during laser notching, i.e. during forming the notch, modulation of the feed, i.e. the relative movement between the laser beam in effective engagement and the workpiece and/or the laser pulse is performed. This modulation enables a notch having differently deep notch sections or notch distances to be formed. By “depth” of the notch section the penetration depth in the direction of the laser beam is understood. Moreover, by variation of the feed rate and/or the pulse parameters the depth of a continuous region, hereinafter referred to as notch basis, can be varied. Such notches exhibit an improved stress concentration factor and thus improved fracture mechanics vis-à-vis the conventional notches having a more or less constant geometry. The method can be realized practically with all types of lasers used m fracture splitting.

The launch of the laser beam is performed preferably obliquely with respect to the longitudinal notch axis.

Surprisingly, it turned out that by a suitable selection of the afore-mentioned criteria a notch provided with a perforation can still be produced even in the case of a very high pulse rate and rapid feed, said notch distance then being considerably larger than the calculated notch distance. This procedure involves the advantage that a high-frequency laser with a very high feed rate can be used so that the laser notch can be formed by far more rapidly and with lower heat introduction than in conventional solutions.

These and other features and advantages of the invention will become apparent to those skilled in the art from the following detailed description and the accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### DETAILED DESCRIPTION OF THE PREFERRED EMBODIMENTS

In accordance with the invention, it is preferred when the feed rate is varied according to a periodic function, for example a sine function, or dependent on the component geometry.

The feed rate during laser machining can vary within the range of from 100 mm/min to 1500 mm/min.

The laser beam can be moved vis-à-vis the idle workpiece by shifting the laser head, for example, or in a substantially simpler manner—by using a tilting mirror (scanner); in kinematic reversal the workpiece can as well be moved vis-à-vis the idle laser, and also mixed forms are of advantage. The laser beam can be launched radially, i.e. perpendicularly to the fracture splitting notch or obliquely with respect to the fracture splitting notch.

In the case of radial launch, the notch sections are thus normal to the notch axis, while in the case of oblique launch they are inclined with respect to the notch axis. The launch is preferably carried out at an angle of ≦45° (with respect to the plane normal to the longitudinal notch axis (in the case of a connecting rod this is the radial plane of the connecting rod top end). In a horizontally bearing connecting rod and a feed direction extending normal thereto (notch axis) the angle thus would be 30° with respect to the horizontal and 60° with respect to the vertical (et. FIG. 11).

The pulse modulation can be performed, for example, by variation of the pulse width, the pulse frequency, the pulse amplitude and/or the pulse phase. These parameters can be varied for pulse modulation alone or in any combination so as to vary the recorded pulse power/pulse energy or, for instance, the pulse sequence at constant pulse power and, accordingly, to vary the notch depth or the notch distances along the course of the notch and thus to further optimize the fracturing behavior, For example, in viscous materials peripheral fracture splitting notches are formed—in those workpieces the notch distance or the notch depth then could be varied m dependence on the course of the fracture splitting notch, for example in the connecting rod top end and along the sections extending outside the actual connecting rod top end.

By appropriately selecting the parameters, for instance modulation can be performed by time-controlled pulse energy ramping, with the pulse frequency remaining substantially constant. By the term “ramping” in general a method is understood in which during a pulse sequence the pulse power is increased toward the ramp and/or is reduced starting from the latter.

Alternatively, the modulation can also be performed by a pulse sequence/pulse frequency modulation, wherein in such case the pulse power can be kept approximately constant.

As mentioned already, also other parameters can be varied.

It is also imaginable to modulate both the feed rate and the pulse, with this modulation being adapted to be performed successively or else overlapping or simultaneously.

In accordance with the invention, it is preferred to use a fiber laser, as it is called, as laser. Such fiber lasers are known from the state of the art so that detailed descriptions of the structure thereof can be dispensed with.

In a variant of the invention a laser having an average power of 50 watt or 100 watt and a pulse rate of by far more than 1 kHz, preferably more than 10 kHz, at a pulse duration of approx. 100-200 us is used, wherein the feed may amount to more than 1000 mm/min. On the other hand, the pulse rate in conventional methods is approximately within the same magnitude, with the pulse frequency being definitely lower, for instance 50 to 140 Hz.

In a preferred embodiment of the invention the notch sections extend out of a continuous notch base.

The workpiece produced according to said method can be, for instance, a connecting rod or a crankcase or any other workpiece in which a bearing eye or any other area is to be split by means of a fracture splitting method.

The workpiece produced according to said method can have notch sections of different depth or different notch distances by varying the feed rate or the pulse of the laser. It is especially preferred when the feed variations are periodically repeated along the notch section.

A laser unit for carrying out the method includes a laser module, a laser head for focusing the laser beam emitted via the laser module on a workpiece to be machined and a feed axis active in the feeding direction. The latter is controllable via a control unit so that the feed can be modulated during laser machining. As an alternative or at the same time, also pulse modulation can be carried out via the control unit.

The notch distance is defined by the period of the pulse modulation, for example by the period of the pulse energy ramping or the pulse frequency modulation. Applicant reserves itself the right to direct a claim hereto.

A highly dynamic feed axis is preferred in this context by which the feed rate variations are feasible at acceleration with more than 0.5 g, preferably within the range of 1 to 2 g. That is to say, the feed rate profiles can be performed sine-shaped with high precision, in the limit case even almost in rectangular shape.

Preferred embodiments of the invention will he illustrated in detail hereinafter by way of schematic drawings, in which:

### BRIEF DESCRIPTION OF THE DRAWINGS

FIG. 1 shows a schematic diagram of a laser unit for producing a fracture splitting notch in a large connecting rod top end,

FIG. 2 shows a strongly enlarged representation of a fracture splitting notch produced according to the method of the invention,

FIG. 3 shows a corresponding representation with a varied laser power and/or pulse rate,

FIG. 4 shows a representation of fracture splitting notches in dependence on the feed;

FIG. 5 shows representations of fracture splitting notches in dependence on the mean laser power;

FIG. 6 shows a diagram for emphasizing the dependence of a notch depth on a feed of the laser beam;

FIG. 7 shows a diagram for emphasizing a feed rate modulation as a function of time;

FIG. 8 shows a diagram and a picture for emphasizing the notch depth being adjusted in dependence on the mean feed rate with feed rate modulation;

FIG. 9 shows pictures of fracture splitting notches in comparable conditions with and without feed rate modulation;

FIG. 10 shows a schematic representation of a laser unit that can he used in a laser method with feed rate modulation;

FIG. 11 shows a schematic diagram of a laser head of the laser unit according to FIG. 10;

FIG. 12 shows a diagram for emphasizing a pulse amplitude modulation of the laser;

FIG. 13 shows a diagram for emphasizing a pulse sequence modulation of the laser;

FIG. 14 is a variant: of the embodiments according to FIGS. 12 and 13, and

FIG. 15 shows a diagram illustrating the effects of a modulation of the feed and the pulse frequency on the notch depth.

### DETAILED DESCRIPTION OF THE DRAWINGS

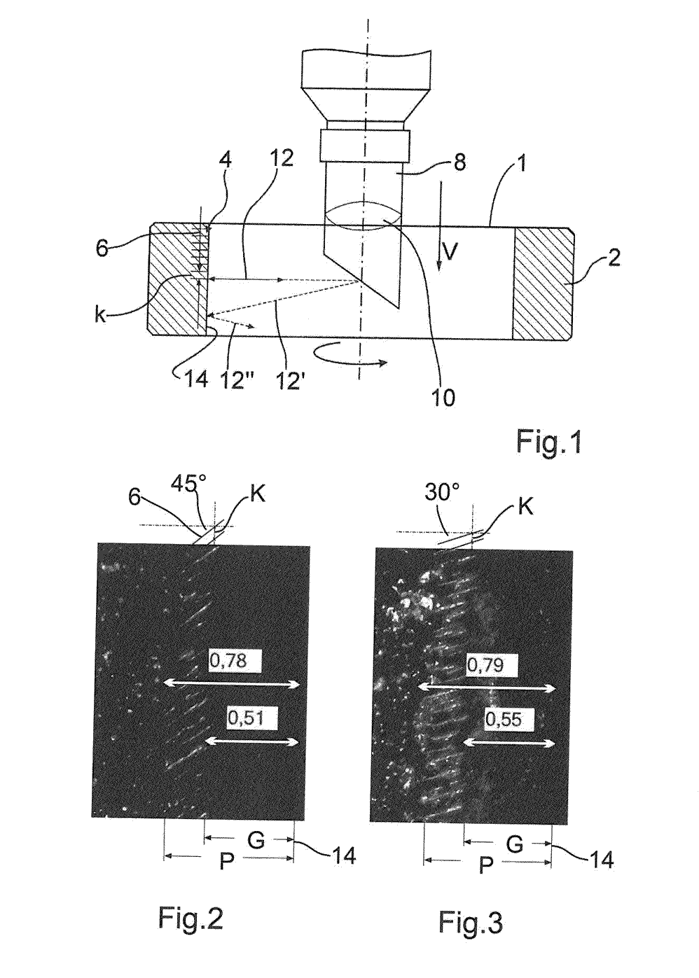

FIG. 1 shows a sectional view of a large connecting rod top end I which is to be separated into a bearing seat and a part on the connecting rod side by fracture splitting. The course of this fracture splitting plane 2 is predetermined by two diametric fracture splitting notches 4 (only one is shown in FIG. 1) which are preferably in the form of a perforation having a plurality of notch sections 6. As is explained in the state of the art described in the beginning, after forming the fracture splitting notches 4 in the left and right wall of the connecting rod top end I in FIG. 1 an expanding mandrel is inserted into the connecting rod top end and then the bearing seat is separated from the rod-side part of the connecting rod by appropriate expansion of the expanding mandrel und support of the connecting rod top end, wherein due to the structural conditions the occurring fracture splitting plane geometry facilitates the accurately fitting assembly of the two members.

For designing the fracture splitting notch 4 a fiber laser is used the laser head 8 of which is schematically shown in FIG. 1. Fiber lasers of this type can basically be diode pumped solid-state lasers, a core of a glass fiber constituting the active medium. The radiation of the solid-state laser is introduced through launching into the fiber in which the actual laser amplification takes place. The beam characteristics and the beam quality of the laser can be adjusted via the geometry of the fiber (glass fiber) so that the laser remains most largely independently of external impacts and exhibits a very simple structure.

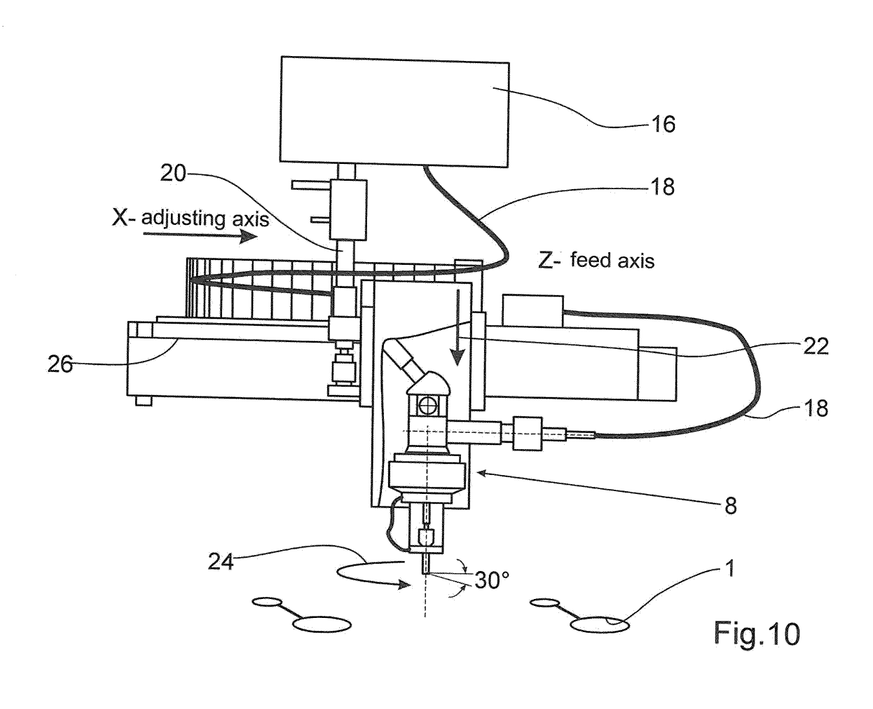

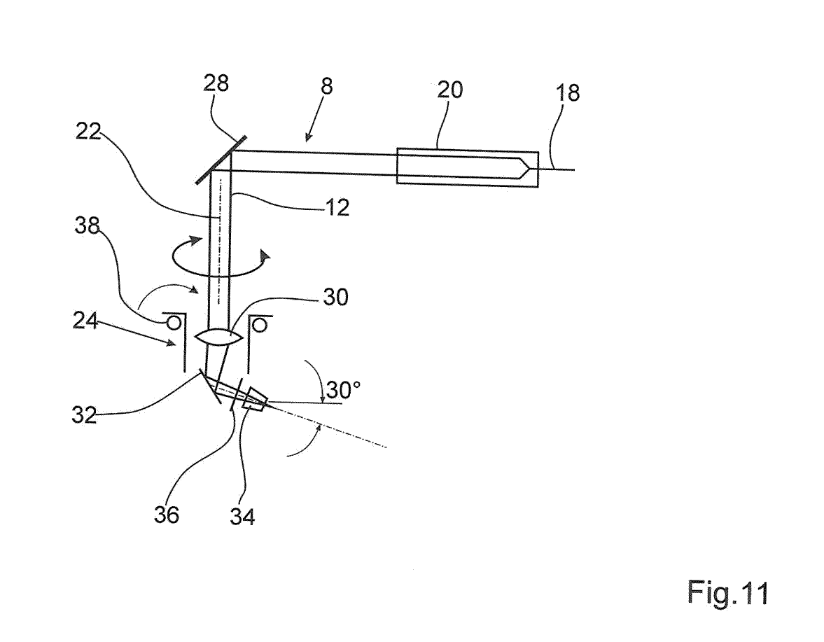

After emerging from said active fiber the laser beam is introduced into a glass fiber through which the radiation is then guided to the laser head 8 shown in FIG. 1 and is focused on the workpiece 1 to be machined via the focusing optics 10 thereof. In the shown embodiment a laser beam 12 impacts in the radial direction, i.e. normal to the notch axis (vertical in FIG. 1). This arrangement may have the drawback that the focusing optics 10 is stained by the melting material, because reflections and possibly residual melt directly return along the optical path due to the 90° launch. When the launch is carried out obliquely, e.g. at 30° or 45°, possibly occurring reflections and residual melt go off under the angle of reflection (cf. FIG. 1: “12”) so that no staining takes place. An oblique launch laser unit is described by way of FIGS. 10 and 11.

A further drawback of the 90° launch consists in the fact that no sluggish or pungent beam control is possible. In the case of inclination, the notch geometry can be additionally influenced by the sluggish (upwards in FIG. 11) or pungent (downwards in FIG. 11) beam control. The notch geometry can be additionally influenced by the air flow acting upon the melt through the nozzle. A subclaim can also be directed to the two afore-mentioned aspects.

These fiber lasers excel by excellent electro-optical efficiencies and an outstanding beam quality having a great depth of focus with a very compact structure so that more cost-effective solutions can be provided with a small constructional space than by conventional lasers. Due to the high peak capacity and the great focusing capacity of fiber lasers, the power density is relatively high so that the evaporated part of material is prevailing. Since part of the energy is converted to heat, however, nevertheless there is still melt and thermal influence of the environment. The residual heat can accumulate so that distinct melting phenomena are obtained that might entail the fact that the calculated notch distance is definitely smaller than the actually occurring notch distance and such notch distance is also comparatively stable while the other parameters are varied.

After machining the connecting rod wall positioned on the left in FIG. 1, the laser head is rotated about 180° and the right-hand connecting rod wall is machined. On principle, also crossheads can be used, however, in which both wall portions can be simultaneously machined. ed.

In the described embodiment the workpiece, i.e. the connecting rod, is fixedly clamped and the laser head 8 is moved at a feed rate V in the axial direction or in parallel to the axis, wherein the laser power is approximately 50 W and the pulse frequency of the laser in the shown embodiment is approximately 20 kHz. The spot diameter is approx. 30 μm, with the feed V amounting to approx. 1500 mm/min, With these parameters a calculated notch distance of approx. 0.00125 mm would be resulting, In fact, the notch distance K (in this case with a laser beam obliquely launched at 45°) is approx. 0.1 mm.

FIG. 2 illustrates a strongly magnified representation of a connecting rod top end concretely machined according to the method of the invention with the afore-mentioned parameters, the laser beam being obliquely (45°) launched in this embodiment. The mean laser power amounts to approx. 50 W and the pulse power is approx. 8 kW. The distance of the perforation (notch distance) K amounts to about 0.1 mm, with a continuous notch base (G) resulting out of which the individual notch sections 6 forming the perforation are extending. In the embodiment according to FIG. 2, the depth of the notch base G amounts to approx. 0.51 mm, while the depth P (viewed in the radial direction) of the notch sections 6 amounts to approx. 0.78 mm (measured from the circumferential wall 14 of the connecting rod top end 1).

FIG. 3 shows a similar embodiment having a reduced laser power (40 W) and a steeper launch (30°) of the laser beam 12—it is recognized that no substantial change is resulting at the notch distance K, the depth G of the notch base and the depth P of the notch sections are slightly greater in the case of the steeper launch mid the reduced laser power (40 W). In the case of the somewhat steeper launch a notch improving the fracturing behavior can thus be formed with even less power than in the afore-described embodiment.

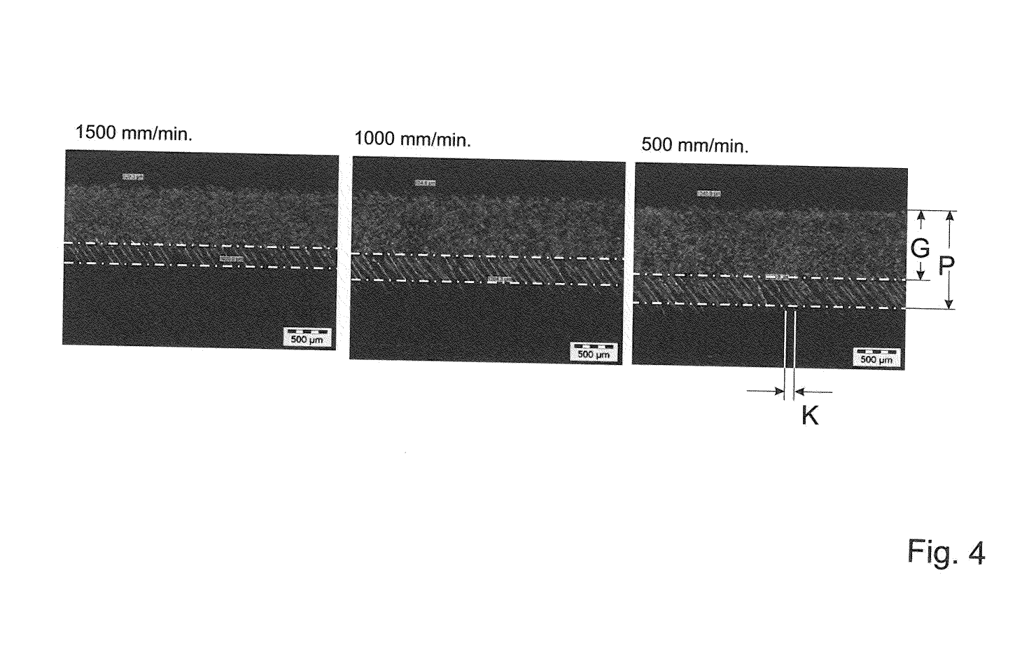

FIG. 4 shows the dependence of the fracture splitting notch on the set feed rate V (see FIG. 1) at which the laser beam is moved in the longitudinal notch direction.

It is clearly evident that at different feed rates (500 mm/min; 1000 mm/min, 1500 mm/min) the notch distance remains almost unchanged. What is clear, however, is that at lower feed rates, on the one hand, the depth G of the notch base is greater and also the axial length of the notch sections (P-G) is inversely proportional to the feed, wherein the differences between 500 mm/min and 1000 mm/min are comparatively small.

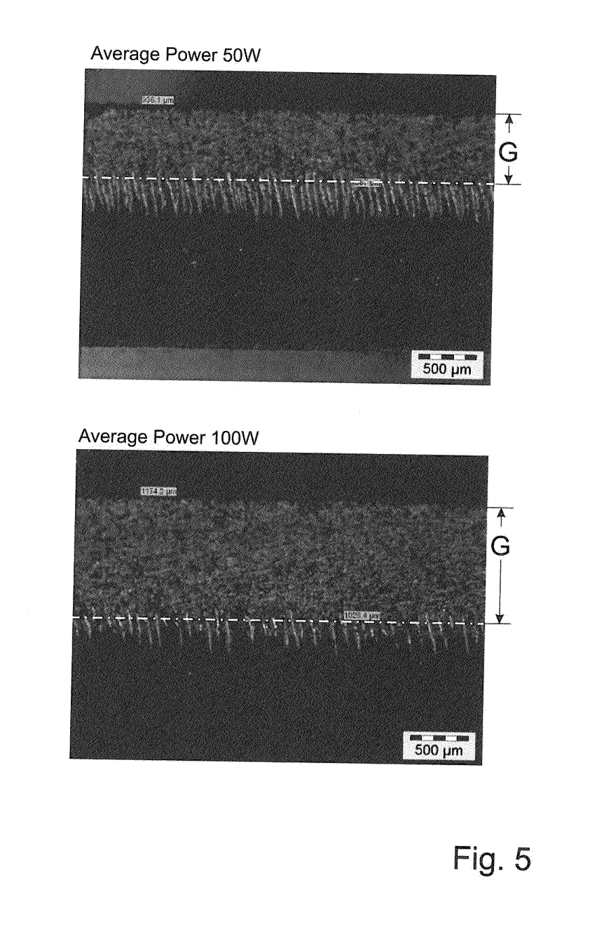

FIG. 5 shows the dependence of the fracture splitting notch on the laser power. In the representation at the top of FIG. 5 a mean laser power of 50 W was set. The fracture splitting notch represented there below results from a mean laser power of 100 W, wherein the other parameters are unchanged. It is clearly evident that with a reduced laser power a somewhat finer notch structure having longer notch sections is formed, wherein—as already indicated in the foregoing—the notch distance remains approximately unchanged, however, Moreover, by the reduced laser power according to expectations a continuous notch base having a somewhat smaller depth G is formed than in the ease of a greater laser power. As regards the fracture mechanics, thus the use of a laser having a comparatively small laser power (50 W and less) should be optimal at an average feed rate ranging from 500 to 1500 mm/min.

The beam quality can be improved by a Q-switch, as it is called. Such Q-switch is an optical component by which in the case of a pulsed laser the pulse is delayed, the pulse duration is reduced and the pulse height (peak performance) is enlarged so that a very sharp laser pulse is obtained which rapidly increases and upon reaching a sharp maximum rapidly decreases again. Without such Q-switch the pulse has a definitely wider and flatter form.

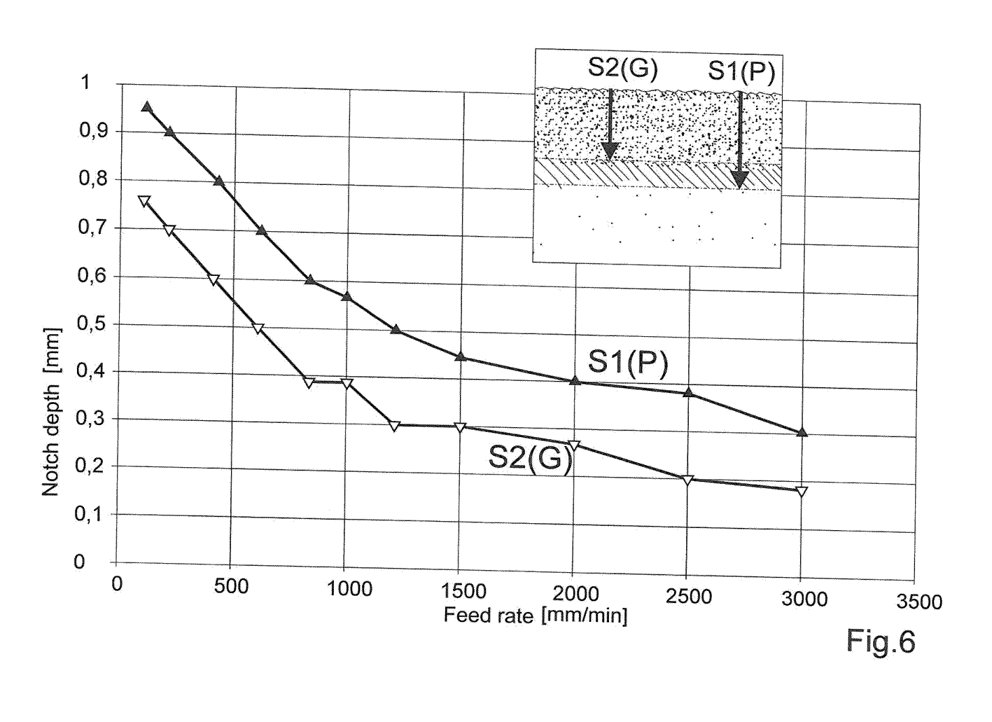

FIG. 6 illustrates the dependence of the occurring notch depth on the feed that is varied between 100 and 3000 mm/min in this context, the measure S2 corresponds to the prescribed measure G (depth of notch base), and the measure S1 corresponds to the total depth P (see FIGS. 2 and 3) of the notch so that the length of the notch sections corresponds to the difference (G-P). The upper curve shows the course of the total depth S1 of the notch, while the lower curve represents the course of the depth of the notch base S2. It is clearly evident that at comparatively low feed rates within the range of up to approx. 800 mm/min a comparatively strong dependence of the notch depth (S1, S2) on the feed rate is provided. At higher feed rates (approx. 800-3000 mm/min) the dependence is by far less distinct. These experiments were carried out at a pulse frequency of 50 kHz and a mean pulse power of 50 W. The dependence of the notch geometry on the feed rate as illustrated by way of the afore-described figures was thus confirmed by the experiments shown in FIG. 6.

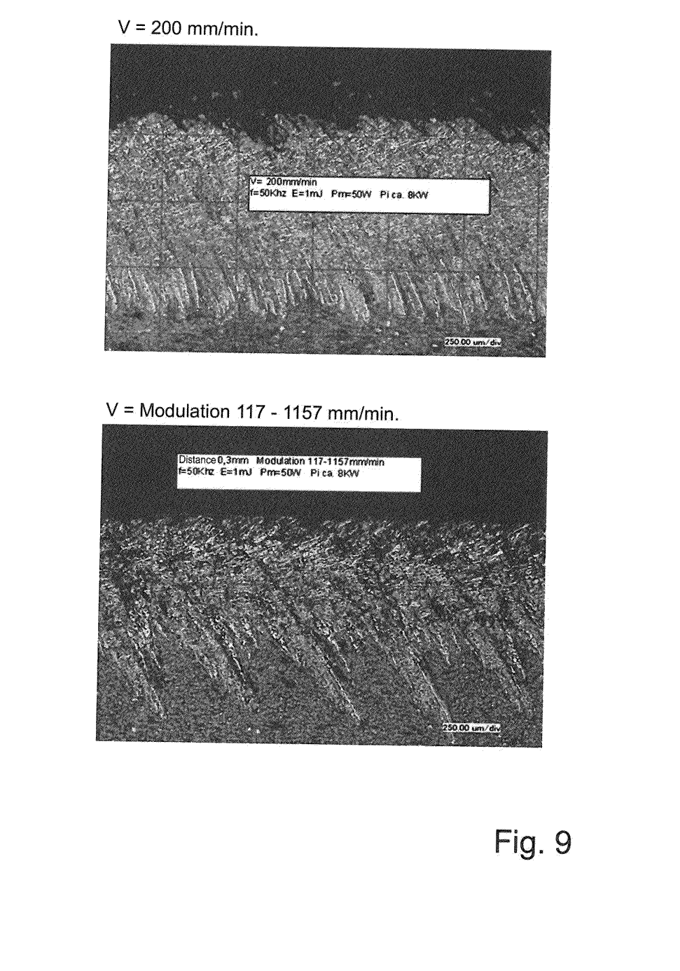

As will be explained in more detail hereinafter, at very low feed rates (less than 200 mm/min) it could be noted that the notch quality was insufficient due to thermal overheating in the area of the notch base. Charred areas were formed which made the workpiece subjected to laser machining practically useless. Said charred areas are shown, for example, at the top of FIG. 9 which will be discussed in detail later below.

In laser machining therefore care should be taken that the feed rate is controlled so that such losses in quality are avoided when forming the fracture splitting notch.

It turned out that those phenomena can be avoided by varying the feed rate during laser machining, wherein a fracture splitting notch is produced which, on the one hand, exhibits sufficient notch depth and, on the other hand, can be formed at high feed rates and thus within short tune, wherein no losses in quality resulting in a deterioration of the fracture mechanics have to be expected.

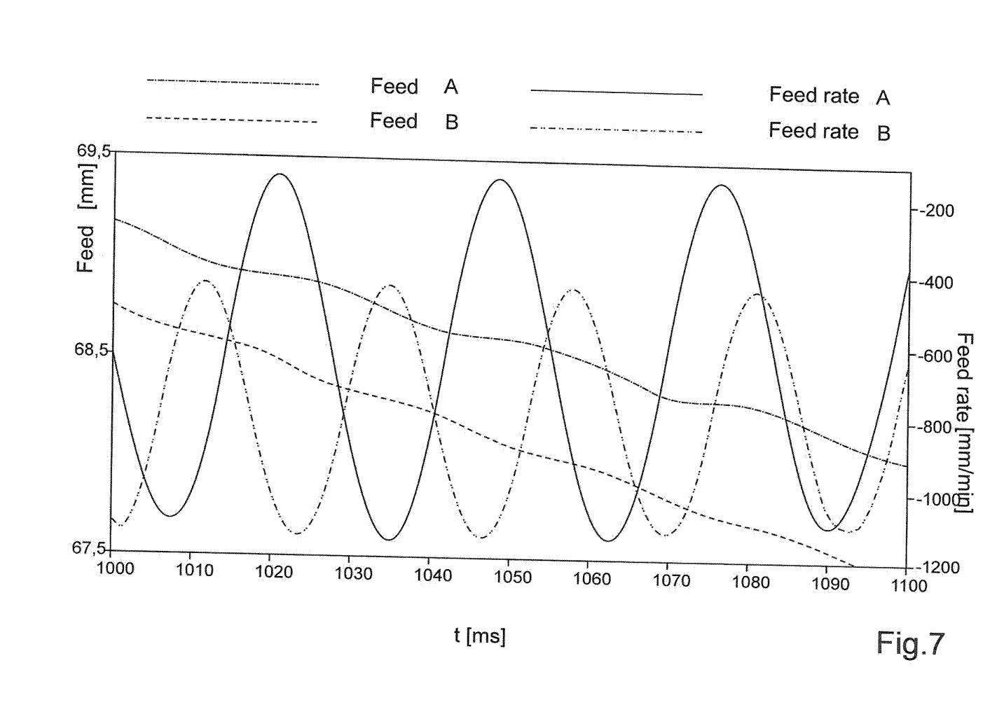

FIG. 7 shows examples of a feed rate modulation, wherein the latter is performed according to a sine function. As a matter of course, the feed rate modulation can also be performed according to other, preferably periodic functions. What is illustrated is the course of the feed rates within a particular feed range which does not correspond to the total length of the fracture splitting notch to be formed as a function of time. In this case, the feed range between 67.5 and 69.5 mm is concretely shown, i.e. merely two 2 mm of the entire fracture splitting notch are shown, but in the areas of the fracture splitting notch that are not shown the rate modulation is carried out correspondingly. The curves represented slightly undulated from the left-hand top to the right-hand bottom (upper curve in broken line/lower curve in continuous line) show the actual feed in the direction of the fracture splitting notch as a function of the time t. During this slightly undulated feed the feed rate is varied according to the plotted sine functions, wherein the sine function having higher amplitude is assigned to the laser path in broken line, whereas the sine function having smaller amplitude is assigned to the laser motion path in continuous line. It is visible that the feed rate is changed at relatively high frequency so that the laser head 8 has to be strongly accelerated and decelerated within a short period of time so as to adjust the motion profile along the fracture splitting notch to be formed.

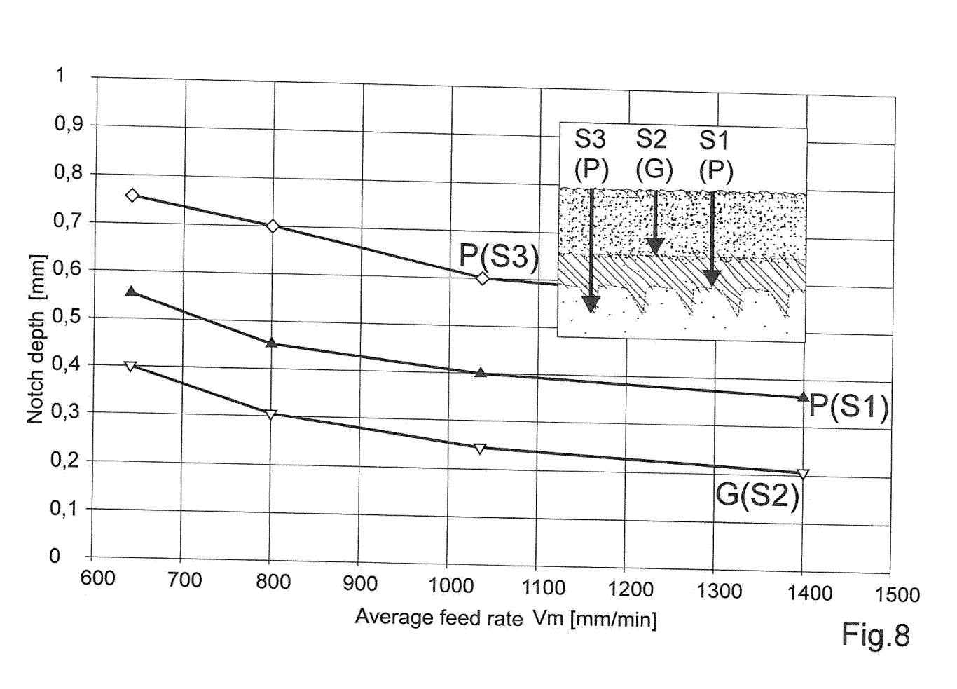

In the diagram according to FIG. 7 the respectively adjusted actual values of feed rate are shown on the right. Accordingly, in the upper rate modulation the rate was varied within the range of from 117 to 1157 mm/min. When forming the fracture splitting notch at such feed rate modulation, a fracture splitting notch geometry is resulting as it is exemplified in FIGS. 8 and 9. FIG. 8 shows a diagram in which the occurring notch depth is adjusted as a function of the average feed Vₘ, i.e. the average value of the afore-described rate modulation. It is visible in FIG. 8 that at an average feed rate of 800 mm/min, for instance (the feed rate in fact varies according to the sine function in accordance with FIG. 7, a fracture splitting notch having the course plotted in FIG. 8 occurs. It is clearly evident that different notch sections are formed from a notch base having the measure S2 (G) corresponding to the sine period. The sections marked by S3 are formed in the areas in which the feed rate is comparatively low. The notch sections marked by S1 are formed in the areas in which the laser moves at a comparatively high speed.

The course of the characterizing parameters S1 (P), S2 (G), S3 (P) in response to the average feed is shown in the diagram according to FIG. 8. The upper curve reproduces the course of the total notch depth (S3) at a low feed rate, the curve S1 reproduces the course of the notch depth at a comparatively high feed rate (always during rate modulation) and the curve S2 reproduces the course of the depth of the notch base. It is found that the notch depth decreases when the average feed rate is increased. However, it is clearly visible that upon a respective speed modulation notch sections having varying notch depths can be formed. It turned out that such notch has definitely improved fracture mechanics vis-à-vis the notches mentioned at the beginning. In other words, by the feed rate modulation comparatively deep and sharp initial notches can be formed which definitely improve the initiating fracture toughness and the arresting fracture toughness vis-à-vis fracture splitting notches including continuous perforation without the feed rate modulation.

Thus it becomes possible to crack also complex components, wherein the modulation of the feed rate can also be carried out in response to the component geometry. That is to say, in very complex components including e.g. breakthroughs in the area of the fracture splitting notch, the feed rate can be adapted to the geometry of the component so that in uncomplicated areas a comparatively high feed rate or amplitude of the feed rate modulation is applied, whereas in more critical areas the feed rate modulation is appropriately reduced so that a lower average feed rate or else a constant feed rate is adjusted.

The advantage of the described feed rate modulation is emphasized by way of FIG. 9.

At the top the latter shows a fracture splitting notch as it would be adjusted at a comparatively low constant feed rate of 200 mm/min. The comparatively large notch depth and the burnings/chars which may occur due to the high heat introduction at a low feed rate are clearly visible. Such fracture splitting notch is practically useless.

On the other hand, in the picture there below a notch produced according to the method of the invention with feed rate modulation is represented, the feed rate having been modulated within the range of between 117 and 1157 mm/min. It is clearly visible that burnings can be reliably avoided in the area of the notch base by such modulation. Furthermore, the notch sections having a larger or smaller depth formed by appropriate rate modulation are visible, wherein the depth is also dependent on the angle of inclination of the laser. In the shown embodiments the angle of inclination, i.e. the launch angle, was approx. 30° with respect to the horizontal in FIG. 9.

By way of the FIGS. 10 and 11, a laser unit is described that is suited especially well for implementing the afore-described method with feed rate modulation. In accordance with FIG. 10, the laser unit includes a laser module 16 which comprises, for instance, a fiber laser and the control of said fiber laser. The control of the laser unit 16 is configured so that the feed rate of the laser beam can be modulated in the afore-described manner.

The laser beam 12 generated by the laser module 16 is guided via light conductors 18 to a re-collimator 20 that is merely indicated, in FIG. 10. In the latter the laser beam is converted to a parallel beam, the beam diameter being within the range of approx. 6 mm. Said parallel beam is then guided via the light conductors 18 to the laser head 8 via which a laser beam is then focused on the workpiece to be machined, in the present case a connecting rod top end 1 of a connecting rod. The focused laser beam is launched at an angle of 30° with respect to the horizontal in FIG. 10. The laser head 8 is configured to have a Z feed axis 22 via which the feed takes place in the longitudinal notch axis. Said feed axis is a highly dynamic axis by which extremely high accelerations are feasible with high closed-loop gain and great jerk so that an extremely precise control of the modulation is required. The accelerations can be, for example, within the range of between 1 and 2 g, the closed-loop gain can be within the range of 10 mm/min (166.71 /s) and the jerk can be more than 400 m/s³. For a two-sided machining of the connecting rod top end 1 the laser head 8 is further configured to have a pivot axis 24 by which the laser head 8 can be pivoted about the Z feed axis 22. The laser unit moreover includes an X adjusting axis 26 via which the entire laser head 8 can be moved in the X direction (radially with respect to the connecting rod top end 1). By such means also sine-shaped fracture splitting notches can be formed.

FIG. 11 illustrates the basic structure of beam guiding in the laser head 8. There is shown the light conductor 18 coupled to the fiber laser (laser module 16). The laser beam is converted in the re-collimator 20 to a parallel beam having a diameter of approx. 6 mm and is then deflected by 90° in the direction of the connecting rod top end axis by a deflecting mirror 28. The deflected laser beam 12 is then focused via optics having a focal length of 100 mm, for instance, on the connecting rod top end wall, wherein an orientation, to the circumferential wall of the connecting rod is performed via another deflecting mirror 32 which in the shown embodiment is inclined at an angle of 60° with respect to the horizontal so that the laser beam impinges on the circumferential wall of the connecting rod resulting in a launch angle of 30° with respect to the horizontal or at an angle of inclination of 60° with respect to the vertical part of the laser beam 12 impinging on the deflecting mirror 32 (deflection 60°). The laser beam exits through a nozzle 34 and in so doing is focused such that the laser spot is located at approx. 3 mm ahead of the exit plane of the nozzle 34. In order to avoid staining of the optics 30 and the mirrors 28, 32 a protective glass 34 is provided in the optical path between the nozzle 34 and the deflecting mirror 32. In the representation according to FIG. 11 also the pivot axis 24 is visible, wherein the laser head 8 is pivoted via a pivot bearing 38 and can be swiveled about the Z feed axis 22 by a motor not shown so that practically every circumferential wall area of the connecting rod can be reached.

When using a fiber laser and by appropriately selecting a feed rate modulation and a comparatively high pulse rate (compared to conventional solutions), thus a perforation can be formed which has an optimum stress concentration factor but can be configured with a substantially lower energy input and with considerably faster feed rates than this is the case in conventional systems.

The experiments implemented illustrate that e.g. in the case of a fiber laser having a power of 50 watt at a pulse frequency of 20 kHz a fracture splitting notch 4 can be formed in which the notch sections 6 have a distance within the range of 1/10 mm, preferably within the range of O.1 to 0.3 mm. It turned out that, even when a laser having a power of only 30 watt is used, a highly effective perforated fracture splitting notch 4 can be formed.

In the afore-described embodiments feed modulation is performed. Alternatively or additionally also a pulse modulation can take place, however, for example in the manner described hereinafter.

On principle, in such pulse modulation a pulse-shaped carrier or base function is modulated, wherein, for instance, the pulse width, the pulse duration or the pulse phase can be varied. Preferably the pulse energy (pulse ramping) or the pulse frequency/pulse sequence is modulated. In pulse amplitude modulation the afore-mentioned rectangular carrier pulse sequence is varied by variation of the pulse amplitudes. In pulse duration modulation the pulse width of the underlying carrier function is appropriately varied. Correspondingly, in a pulse phase the pulse position is phase-shifted vis-à-vis the respective carrier function, with fixed pulse width and pulse amplitude being used.

Hereinafter a time-controlled pulse energy ramping with constant pulse frequency and a pulse sequence modulation of approximately constant pulse power will be illustrated.

In the time-controlled pulse energy ramping the time control is adapted to the present, preferably constant feed rate and the desired notch section grid (perforation grid). The pulse energy ramp shape approximately depicts the perforation shape in this case.

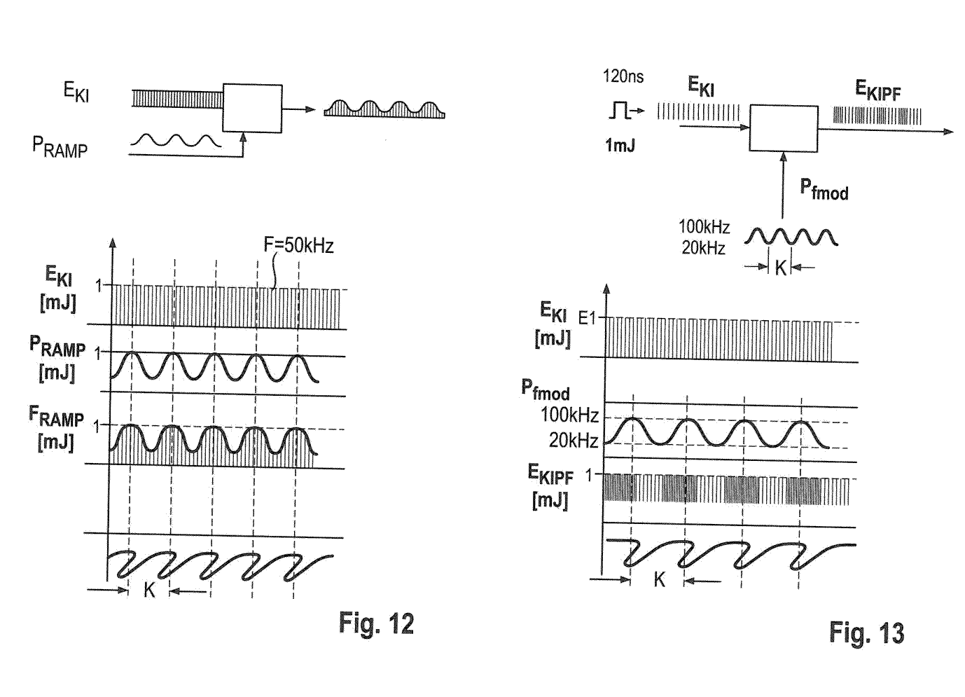

By way of FIG. 12 such modulation with a time-controlled pulse energy ramping is shown. As starting or carrier function the course of the pulse energy E_{K1} is represented in response to time, wherein the pulse energy for example amounts to 1 mJ at a pulse length of 120 ns and a frequency of 50 kHz. This carrier function is superimposed by a ramp-shaped modulation of the pulse energy (P_{Ramp}) the course of which is shown in FIG. 12. The pulse ramp shape approximately has a sine shape without zero crossing in the shown embodiment, On principle, however, also other ramp shapes having an increasing and decreasing flank and a plateau region of constant power/energy can be employed. In the shown embodiment, the modulation of the starting or carrier function is performed such that the predetermined maximum pulse energy (1 mJ) is periodically reduced, such reduction and the connected increase to the maximum pulse energy (ramping) having an approximately sine-shaped course.

The appropriate modulation of the carrier function E_{K1} then results in the shown pulse energy variation having a ramp shape (E_{Ramp}). It is clearly evident that the time sequence of the ramps, i.e. the pulse energy ramp shape defines the notch distance K so that the pulse energy ramp shape depicts the perforation shape. In this embodiment a constant feed rate is provided, the latter amounting to approx. 200 mm/min and the pulse frequency/period of the function P_{Ramp} constantly amounting to 11.1 Hz in the illustrated embodiment. The pulse energy (E_{Ramp}) of the laser varies according to the ramp function at the same frequency, wherein the notch section K is adjusted according to said frequency and the selected feed rate. In this embodiment, too, a notch distance K is thus adjusted which is definitely larger than it is resulting by calculation from the actual pulse frequency (50 kHz (cf. function E_{K1})) and the selected feed rate, because such notch distance K is substantially dependent on the selected frequency/period of the ramp function (11.1 Hz).

FIG. 13 shows an embodiment with pulse sequence or pulse frequency modulation. Similarly to the afore-described embodiment, an output or carrier pulse sequence having pulse energy of 1 mJ and a pulse length of 120 ns is taken as a basis. This output function is modulated during pulse sequence modulation by varying the pulse frequency between a maximum value of 100 kHz and a minimum value of 20 kHz, the variation again being performed approximately sine-shaped according to FIG. 13. The period of this pulse sequence or frequency variation then in turn determines the notch distance K. It is clearly visible that in the areas having a pulse power of 1 mJ and a high frequency within the range of 100 kHz the maximum notch depth is formed. Accordingly, the notch depth is dependent on the pulse frequency (with constant pulse power). In the shown embodiment, the period of pulse modulation is 11.1 Hz. The feed rate is 200 mm/min. Such modulation of the carrier function results in a pulse sequence modulation E_{KJPC} in which the pulse sequence is varied between 10 and 50 μs is at a modulation frequency (pulse train period) of 11.1 Hz.

Similarly to the embodiment according to FIG. 12, the notch distance K in such pulse sequence modulation results from the period (11.1 Hz) so that by appropriately selecting the frequency period (pulse sequence modulation) or the period of the ramp form (pulse energy ramping) the perforation grid, i.e. the notch distance K is resulting. In the described embodiments, for example a notch distance of 0.3 mm is adjusted. This type of modulation can also be referred to as “frequency wobbling”.

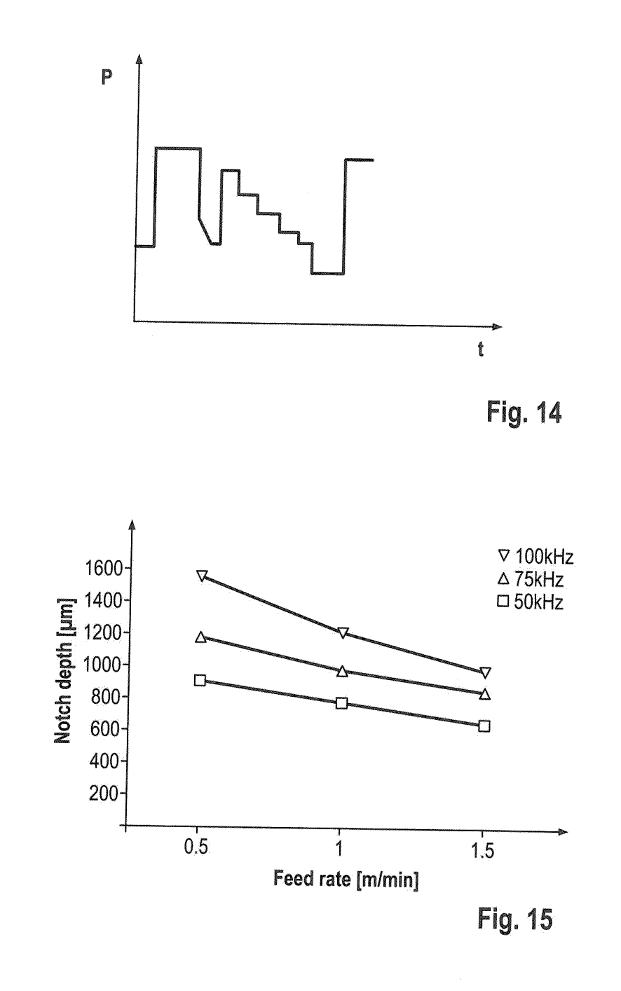

FIG. 14 illustrates in a very general form an embodiment in which the notch depth or the notch distance is changed by variation of the pulse power P, with this power regulation being performed dynamically. Both the pulse width and the pulse amplitude and also the pulse frequency, where appropriate, are varied.

Basically during pulse modulation also a burst mode can be employed in which the laser pulses are output from an energy storage device until a fixed number of pulses is reached or the energy storage device is discharged. It is assumed in this case that then the fracture splitting notch is completely formed and the workpiece is fed to another station. The energy storage device is charged during such workpiece handling and is then ready for the next laser machining.

By way of the diagram shown in FIG. 15 the findings from the invention are to be summarized once again. This diagram shows the depth of the notch as a function of feed and of pulse frequency.

As explained in detail in the foregoing, with comparatively low feed rates a larger notch depth is obtained, while upon modulation of the pulse frequency the notch depth increases with higher frequency. Accordingly, with a constant feed rate the notch depth at high frequency (100 kHz) is almost twice as large as with a pulse frequency of 50 kHz. In this case it is provided that a laser is used having a mean power of 100 watt with pulse energy of 1 mJ, pulse length of 130 as and launch angle of 90°.

As repeatedly explained already, the feed rate as well as the laser pulse can be modulated. Applicant tends to vary the feed rate at maximum laser power, wherein always maximum laser power can be used for working due to the almost linear dependence of the notch depth on the modulation of the feed rate. By the use of linear motor technology the non-machining times can be considerably reduced, with the feed rate modulation being feasible in a relatively simple manner. The modulation can be even further facilitated when the laser is configured to include scanner technology, with the alignment of the laser being performed via a tilting mirror or optics so that a linear axis can be largely dispensed with.

The invention relates to a method for fracture splitting workpiece and to a workpiece that is produced according to such a method. According to the invention, the feed rate and/or the laser pulse is modulated during the laser machining process dependent on the work-piece geometry and/or the laser power.

Although the best mode contemplated by the inventors of carrying out the present invention is disclosed above, practice of the above invention is not limited thereto. It will be manifest that various additions, modifications and rearrangements of the features of the present invention may be made without deviating from the spirit and the scope of the underlying inventive concept.

1. A method for fracture splitting of workpieces by means of laser energy, wherein by relative displacement between a laser beam and the workpiece a fracture splitting notch predefining a fracture splitting plane is formed, said fracture splitting notch being in the form of a perforation including notch sections, characterized in that the feed rate (V) and or the pulse parameters of the laser are varied during machining,

2. The method according to claim 1, wherein the laser beam is launched obliquely with respect to the longitudinal notch axis.

3. The method according to claim 31, wherein the feed rate (V) is varied according to a periodic function, for instance a sine function.

4. The method according to claim 1, wherein the feed rate is varied between 100 mm/min and 1500 mm/min.

5. The method according to claim 1, wherein the pulse modulation is performed by variation of the pulse width., the pulse frequency, the pulse amplitude and/or the pulse phase, with parameters being modulated individually or in any combination.

6. The method according to claim 5, wherein the modulation is performed by time-controlled pulse energy ramping at constant pulse frequency.

7. The method according to claim 5, wherein the modulation is performed by pulse sequence/pulse frequency modulation, preferably within the range of from 100 kHz and 20 kHz, with constant pulse power.

8. The method according to claim 1, wherein the laser used is a fiber laser.

9. The method according to claim 1, wherein the fracture splitting notch has a continuous notch base out of which the notch sections are extending.

10. A workpiece, especially a connecting rod or a crankcase, manufactured in accordance with a method according to claim 1.

11. The workpiece according to claim 10, wherein said workpiece has approximately periodically recurring sequences of one or more notch sections of small depth and one or more notch sections of larger depth or different notch depths (P) dependent on the workpiece geometry.

12. A laser unit for implementing the method according to claim 1, comprising a fiber laser, a laser bead for focusing a laser beam onto a workpiece to be machined, comprising at least one feed axis acting in the feeding direction and comprising a control unit for varying the feed rate and/or pulse parameters of the laser while forming the fracture splitting notch.

13. The laser unit according to claim 12, wherein the feed axis is configured so that, while forming the fracture splitting notch, changes of the feed rate are possible with an acceleration of >0.5 g, preferably up to 2 g.

14. The laser unit according to claim 12, wherein the mean power of the fiber laser amounts to 100 watt and less at a maximum pulse rate of more than 20 kHz, preferably approx. 100 kHz.

15. The laser unit according to claim 12, wherein a period of modulation is selected so that a predetermined notch distance (K) is adjusted.
